(19) United States
(12) Patent Application Publication
(10) Pub. No.: US 2011/0148868 A1
(43) Pub. Date: Jun. 23, 2011

(54) APPARATUS AND METHOD FOR RECONSTRUCTING THREE-DIMENSIONAL FACE AVATAR THROUGH STEREO VISION AND FACE DETECTION

(75) Inventors: Ji Ho CHANG, Daejeon (KR); Jae Il CHO, Daejeon (KR); Eul Gyoon LIM, Daejeon (KR); Dae Hwan HWANG, Daejeon (KR)

(73) Assignee: Electronics and Telecommunications Research Institute, Daejeon (KR)

(21) Appl. No.: 12/973,326

(22) Filed: Dec. 20, 2010

(30) Foreign Application Priority Data
Dec. 21, 2009 (KR) 10-2009-0127717

(51) Int. Cl. G06T 15/00

(52) U.S. Cl. 345/419

(57) ABSTRACT

Provided are an apparatus and method for reconstructing 3D face avatar. The apparatus includes a face detection unit, a stereo matching unit, a bilateral filter, and a texture mapping unit. The face detection unit receives a left image and right image of a user, and detects a face image of the user from the left and right images using a face detection algorithm. The stereo matching unit receives the left and right images of the user, and creates a depth map image from the left and right images through a stereo matching operation which uses disparity between the left and right images. The bilateral filter abstracts the detected face image through a bilateral filtering operation. The texture mapping unit texture-maps the abstracted face image on the created depth map image to reconstruct a 3D avatar.

### CROSS-REFERENCE TO RELATED APPLICATIONS

This application claims priority under 35 U.S.C. § 119 to Korean Patent Application No. 10-2009-0127717, filed on Dec. 21, 2009, in the Korean Intellectual Property Office, the disclosure of which is incorporated herein by reference in its entirety.

### TECHNICAL FIELD

The following disclosure relates to an apparatus and method for reconstructing Three-Dimensional (3D) face avatar, and in particular, to an apparatus and method for reconstructing Three-Dimensional (3D) face avatar by using a stereo vision system and a face detector.

### BACKGROUND

Recently, avatars that represent users as featured characters are widely being used on 3D games or Web. In the related art, avatars are reconstructed through some combinations that are provided from a content-providing company. However, a method has recently been developed which inputs the photographs or body information of users to reconstruct avatars and thus reconstructs avatars more similar to users. The method is used to create characters used in games, avatar models capable of being displayed on Web, or video for showing in video phone.

As related art methods for reconstructing avatar, there are methods below.

First, there is a method that reconstructs avatars with users' photographs. As an example of such a method, there is a method where separate technical designers create avatars with Two-Dimensional (2D) live photographs. In the method, designers may appropriately apply users' requests, but much time and cost are required.

As other methods, there are a method that receives live photographs and the body type information of users and reconstructs avatars with a basic body type of 3D avatars which are stored in advance, and a method that detects feature points from photographs and reconstructs avatars by using the most similar face combination in a database. In the method, time and cost may be saved, but avatars dissimilar to users are frequently reconstructed.

As another method, there is a method that reconstructs avatars with a 3D scanner. Such a method requires a high-cost 3D scanner, and it is difficult for users to use the method. Particularly, the method is unsuitable for a case where change is required in real time like video phone using portable phones.

### SUMMARY

In one general aspect, an apparatus for reconstructing Three-Dimensional (3D) face avatar includes: a face detection unit receiving a left image and right image of a user, and detecting a face image of the user from the left and right images using a face detection algorithm; a stereo matching unit receiving the left and right images of the user, and creating a depth map image from the left and right images through a stereo matching operation which uses disparity between the left and right images; a bilateral filter abstracting the detected face image through a bilateral filtering operation; and a texture mapping unit texture-mapping the abstracted face image on the created depth map image to reconstruct a 3D avatar.

In another general aspect, a method for reconstructing Three-Dimensional (3D) face avatar includes: detecting a face image of a user from the left and right images of the user by using a face detection algorithm; receiving the left and right images of the user, and creating a depth map image from the left and right images through a stereo matching operation which uses disparity between the left and right images; abstracting the detected face image through a bilateral filtering operation; and texture-mapping the abstracted face image on the created depth map image to reconstruct a 3D avatar.

Other features and aspects will be apparent from the following detailed description, the drawings, and the claims.

### BRIEF DESCRIPTION OF THE DRAWINGS

FIG. 1 is a block diagram illustrating an apparatus for reconstructing 3D face avatar according to an exemplary embodiment.

FIG. 2 is a flowchart illustrating a method for reconstructing 3D face avatar according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

An apparatus and method for reconstructing face avatar according to exemplary embodiments solve the above-described limitations, and enable users to create avatars using their faces in real time through an abstraction technology such as a stereo matching technology, a face detection technology and a bilateral filtering technology, for enabling easy use even in terminal equipment such as portable phones or notebook computers that may be carried by users.

A stereo matching algorithm is technology that obtains the depth map of an image by using the images of two parallel right and left cameras. The depth map of an image may be calculated with the distance information of a pixel unit, and the stereo matching algorithm has a simple configuration relative to a laser finder or other 3D scanner and consumes a small amount of power.

A face detector detects a person pattern existing in an image on the basis of image information that is inputted from a camera, and effectively detects a face from the image information of various indoor and outdoor situations obtained from a camera, through a video processing technique.

A bilateral filter abstracts an image according to a predetermined parameter, and thus may obtain a cartoonized result. In exemplary embodiments, users may reconstruct an avatar close to a live image and a cartoonized 3D face avatar by controlling a parameter.

An apparatus and method for reconstructing face avatar according to exemplary embodiments improve limitations that the existing technologies make it difficult to reconstruct avatars in real time in portable equipment (for example, portable phones, net-book computers and notebook computers) and cannot satisfy users' requirements, through the above-described technologies.

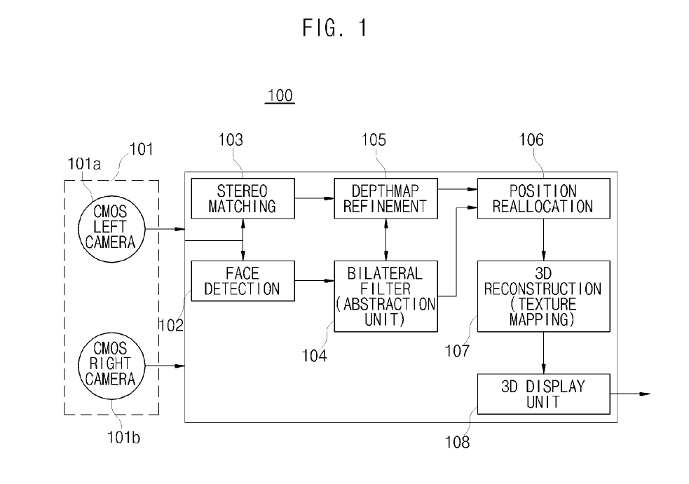

FIG. 1 is a block diagram illustrating an apparatus for reconstructing 3D face avatar according to an exemplary embodiment.

Referring to FIG. 1, an apparatus 100 for reconstructing 3D face avatar according to an exemplary embodiment receives a left/right image including the face shape of a user and reconstructs a 3D avatar (for example, 3D face avatar) by using the left/right image. For this, the apparatus 100 for reconstructing 3D face avatar includes an image obtainment unit 101 for creating the left/right image, a face detection unit 102, a stereo matching unit 103, a bilateral filter 104, a depth map refinement unit 105, a position reallocation unit 106, a texture mapping unit 107. The apparatus 100 further includes a display unit 108 for displaying the 3D avatar that is reconstructed by the texture mapping unit 107.

The image obtainment unit 101 includes a left camera 101a and a right camera 101b that are arranged in parallel. The left image of a user is obtained by the left camera 101a, and the right image of the user is obtained by the right camera 101b. The obtained left and right images are transferred to the stereo matching unit 103 and the face detection unit 102, respectively. The left and right cameras 101a and 101b may be implemented as a Complementary Metal-Oxide-Semiconductor (CMOS) camera or a Charge-Coupled Device (CCD) camera, and may also be implemented as all sorts of imaging means that may capture the entire figure of the user.

The face detection unit 102 detects a face region from one of the left and right face images, or detects a face region from all of the left and right face images. The face detection unit 102 may detect the face region through a face detection algorithm such as AdaBoost. The face detection unit 102 transfers the range value (for example, all pixel coordinates included in the face region) of the detected face region and image information (for example, all the gray scale values of the pixel coordinates included in the face region) to the bilateral filter 104.

The stereo matching unit 103 receives the left and right images, and creates a depth map image for an entire image through a stereo matching algorithm that uses disparity between the pixels of the left and right images. At this point, since the images inputted to the stereo matching unit 103 are left and right images including the entire figure of the user instead of left and right face images including only the face of the user, there is much calculation amount in an operation of performing a stereo matching operation. Therefore, depending on the case, the stereo matching operation may be performed only for the left and right face images detected by the face detection unit 102.

The bilateral filter 104 bilateral-filters the face image detected by the face detection unit 102 to abstract or cartoonize the face of the user. At this point, a parameter necessary for an abstraction operation is inputted by the user. As a nonlinear filter, the bilateral filter 104 shows an output value as the adaptive average of an input. When an input image having noise is inputted, a Gaussian function being a low pass filter is used for removing the noise. Herein, an intensity-based edge stop function that receives a brightness value difference with respect to adjacent pixels is used as the weight value of a distance-based Gaussian filter coefficient, in an input image. That is, by making the difference of brightness values great and lowering the weight value of the Gaussian filter coefficient for a portion having an edge component, an edge is prevented from becoming blurred. By increasing a weight value for a flat plane where the difference of brightness values is small, noise is removed. In the bilateral filter 104, a filtering operation similar to a live image may be performed according to parameters that are inputted by the user. Therefore, an abstraction level representing a degree of abstraction may be selected.

The depth map refinement unit 105 receives a depth map image, corresponding to a face region, from the stereo matching unit 103, and performs a refinement operation for decreasing a noise component or error that is included in the depth map image.

Image information that is obtained through the bilateral filter 104 and the depth map refinement unit 105 requires a position reallocating operation due to an extraction operation or various factors. For performing the position reallocating operation, the position reallocation unit 106 extracts the feature point of a depth map image that is refined by the depth map refinement unit 105 and the feature point of a face image that is filtered by the bilateral filter 104, and it reallocates the positions of the two images so as to 1:1 match the two images.

The texture mapping unit 107 receives the reallocated face image (bilateral-filtered face image) and the depth map image, and configures a 3D map from the reallocated face image on the basis of depth map information included in the depth map image. Subsequently, the texture mapping unit 107 performs texture mapping that coats the color value of the face image as a texture on the configured 3D map. For increasing reality, the texture mapping unit 107 performs texture mapping that coats the color value of the face image as a texture on the configured 3D map, and thus reconstructs a 3D avatar to which the edge features of the eyes, nose, mouth and face of the face image are applied. The reconstructed 3D avatar is displayed to the user by the display unit 108.

The above-described elements 101 to 107 may be implemented using an accelerator such as hardware or Graphics Processing Unit (GPU) when the guarantee of real time is required according to applications. The elements 101 to 107 may be implemented in software when real-time processing is not required. The elements 101 to 107 may be implemented in a program type that is stored in a computer-readable storage medium (for example, ROMs, RAMs, CD-ROMs, DVDs, magnetic tapes, floppy disks, registers, buffers, optical data storage devices, and carrier waves).

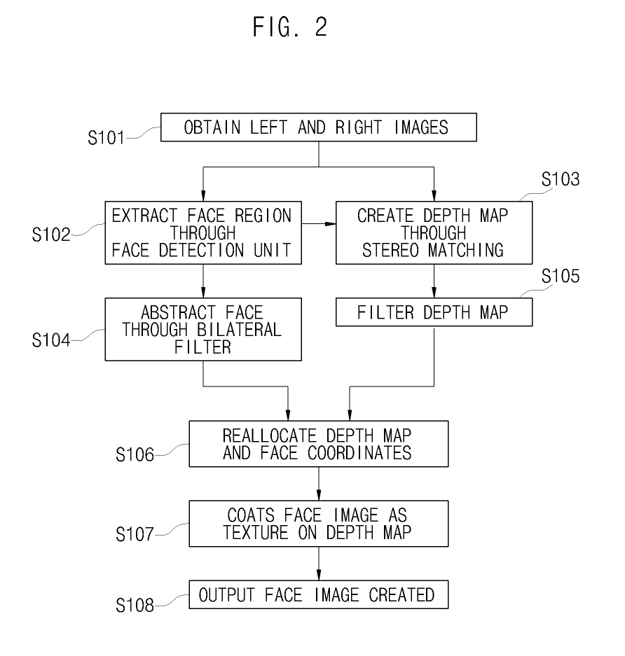

FIG. 2 is a flowchart illustrating a method for reconstructing 3D face avatar according to an exemplary embodiment.

Referring to FIG. 2, for performing a stereo matching operation, left and right images are first obtained from two left and right cameras that are arranged in parallel in operation S101.

Subsequently, a face region is extracted from one or all of the left and right images through various face detection algorithms in operation S102, and the extracted face region is abstracted or cartoonized through a bilateral filtering operation in operation S104. Moreover, a depth map is created through a stereo matching algorithm that uses disparity between the left and right images in operation S103. At this point, a filtering operation on the depth map is performed for reducing the noise component or error of the created depth map in operation S105. In the bilateral filtering operation, a filtering operation close to a live image may be performed according to parameters used. That is, an abstraction level may be selected according to parameters used.

Image information that is obtained in operations S104 and S105 requires the reallocation of pixels due to the extraction operation or various factors. Accordingly, a position reallocation operation is performed that extracts feature points from each image information and controls two image information (for example, the abstracted face image and the depth map image from which noise has been removed) to 1:1 match them in operation S106.

Next, an operation is performed that texture-maps the color value of the abstracted face image as a texture on the reallocated depth map image in operation S107. As the result of this operation, a 3D avatar is reconstructed in operation S108. Consequently, all operations for reconstructing the 3D avatar are ended.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for reconstructing Three-Dimensional (3D) face avatar, comprising:
a face detection unit receiving a left image and right image of a user, and detecting a face image of the user from the left and right images using a face detection algorithm;
a stereo matching unit receiving the left and right images of the user, and creating a depth map image from the left and right images through a stereo matching operation which uses disparity between the left and right images;
a bilateral filter abstracting the detected face image through a bilateral filtering operation; and
a texture mapping unit texture-mapping the abstracted face image on the created depth map image to reconstruct a 3D avatar.

2. The apparatus of claim 1, further comprising: an image obtainment unit comprising left and right cameras which are arranged in parallel, obtaining the left image of the user through the left camera, obtaining the right image of the user through the right camera, and transferring the obtained left and right images to the face detection unit and the stereo matching unit.

3. The apparatus of claim 2, wherein the left and right cameras are Complementary Metal-Oxide-Semiconductor (CMOS) cameras which are mounted on mobile equipment.

4. The apparatus of claim 1, further comprising: a position reallocation unit extracting a feature point of the abstracted face image and a feature point of the depth map image, and reallocating the extracted feature points to be 1:1 matched.

5. The apparatus of claim 4, further comprising: a depth map refinement unit receiving the depth map image from the stereo matching unit, and removing a noise and error of the depth map image to provide the depth map image to the position reallocation unit.

6. The apparatus of claim 1, wherein the bilateral filter determines an abstraction level according to a parameter which is inputted by the user, and controls abstraction of the detected face image according to the determined abstraction level.

7. The apparatus of claim 1, wherein the face detection unit, the stereo matching unit, the bilateral filter and the texture mapping unit are comprised in one module.

8. The apparatus of claim 7, wherein the one module is mounted on mobile equipment.

9. A method for reconstructing Three-Dimensional (3D) face avatar, the method comprising:
detecting a face image of a user from the left and right images of the user by using a face detection algorithm;
receiving the left and right images of the user, and creating a depth map image from the left and right images through a stereo matching operation which uses disparity between the left and right images;
abstracting the detected face image through a bilateral filtering operation; and
texture-mapping the abstracted face image on the created depth map image to reconstruct a 3D avatar.

10. The method of claim 9, further comprising: obtaining the left and right images of the user through a left camera and a right camera which are arranged in parallel, respectively.

11. The method of claim 9, further comprising: extracting a feature point of the abstracted face image and a feature point of the depth map image, and reallocating the extracted feature points to be 1:1 matched.

12. The method of claim 9, wherein the abstracting of the detected face image comprises:
determining an abstraction level according to a parameter which is inputted by the user; and
controlling abstraction of the detected face image according to the determined abstraction level.
